(19) United States
(12) Patent Application Publication
(10) Pub. No.: US 2008/0279416 A1
(43) Pub. Date: Nov. 13, 2008

(54) PRINT MATCHING METHOD AND SYSTEM USING PHASE CORRELATION

(75) Inventors: PETER Z. LO, LAKE FOREST, CA (US); XIAOSHENG SU, BEIJING (CN)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/747,499

(22) Filed: May 11, 2007

(51) Int. Cl. G06K 9/00

(52) U.S. Cl. 382/100

(57) ABSTRACT

A system includes an interface receiving a search and file print and a processing device. The processing device performs a method that includes: performing at least one of a first comparison of quality of the search and file prints to a quality threshold, a second comparison of a minutiae matching score for the search and file prints to a minutiae matching score threshold, and a third comparison of a ridge distance of the search and file prints to a ridge distance threshold; determining that a phase correlation between the search and file prints is to be performed based on results of the at least one of the first, second and third comparisons; aligning the search and file prints and performing the phase correlation to calculate a phase correlation score; and modifying the minutiae matching score based on the calculated phase correlation score.

### CROSS-REFERENCE TO RELATED APPLICATIONS

The present application is related to the following U.S. applications commonly owned together with this application by Motorola, Inc.:

Ser. No. 11/456622, filed Jul. 11, 2006, titled “Method and Apparatus for Adaptive Hierarchical Processing of Print Images” by Lo, et al. (attorney docket no. CM09426G);

Ser. No. 11/554720, filed Oct. 31, 2006, titled “Print Matching Method and Apparatus Using Pseudo-Ridges by Lo, et al. (attorney docket no. CM09327G); and

Ser. No. 11/742820, filed May 1, 2007, titled “Print Matching Method and System Using Direction Images” by Lo, et al. (attorney docket no. CM11011G).

### TECHNICAL FIELD

The technical field relates generally to print identification systems and more particularly to print matching using phase correlation.

### BACKGROUND

Identification pattern systems, such as ten prints or fingerprint identification systems, play a critical role in modern society in both criminal and civil applications. For example, criminal identification in public safety sectors is an integral part of any present day investigation. Similarly in civil applications such as credit card or personal identity fraud, print identification has become an essential part of the security process.

An automatic fingerprint identification operation normally consists of two stages. The first is the registration stage and the second is the identification stage. In the registration stage, the register's prints (as print images) and personal information are enrolled, and features, such as minutiae, core, delta, and classification type, are extracted. Classification type may be, for example, whorl, left loop, right loop, tented arch, and plain arch. Moreover, image quality at individual pixel locations or at blocks of pixels within the direction image can be determined using any suitable means, to facilitate implementations of various embodiments. An illustrative scale for image quality is from 0 in to 100 in, with 0 in being a lowest quality and 100 in being a highest quality. Direction images based on the print images may also be generated depending on the particular matching algorithm being implemented.

The personal information and the extracted features (and perhaps the print images and direction images) are then used to form a file record that is saved into a database for subsequent print identification. These features may be stored as a template with a standard exchangeable format. Moreover, since storage of a direction image (or other print image) in a regular format can use more storage space than is desirable for some implementations, the direction images may alternatively be quantized into a smaller range of values, and the direction images may further be compressed using any suitable image or data compression technique to minimize storage requirements. For example, the number of directions in a direction image may be quantized into M and the dimensionality of the direction image reduced to RxC from RnxCn for computational efficiency, wherein a block (of pixels) represents (RnxCn/RxC) pixels.

Present day automatic fingerprint identification systems (AFIS) may contain several hundred thousand to a few million of such file records. In the identification stage, print features from an individual, or latent print, and personal information are extracted to form what is typically referred to as a search record. The search record is then compared with the enrolled file records in the database of the fingerprint matching system. In a typical search scenario, a search record may be compared against millions of file records that are stored in the database and a list of match scores is generated after the matching process. Candidate records are sorted according to match scores. A match score is a measurement of the similarity of the print features of the identified search and file records. The higher the score, the more similar the file and search records are determined to be. Thus, a top candidate is the one that has the closest match.

However it is well known from verification tests that the top candidate may not always be the correctly matched record because the obtained print images may vary widely in quality. Smudges, individual differences in technique of the personnel who obtain the print images, equipment quality, and environmental factors may all affect print image quality. To ensure accuracy in determining the correctly matched candidate, the search record and the top “n” file records from the sorted list are provided to an examiner for manual review and inspection. Once a true match is found, the identification information is provided to a user and the search print record is typically discarded from the identification system. If a true match is not found, a new record is created and the personal information and print features of the search record are saved as a new file record into the database.

Many solutions have been proposed to improve the accuracy of similarity scores and to reduce the workload of manual examiners. These methods include: designing improved fingerprint scanners to obtain better quality print images; improving feature extraction algorithms to obtain better matching features or different features with more discriminating power; and designing different types of matching algorithms from pattern based matching to minutiae and texture based matching, to determine a level of similarity between two prints.

Current matching algorithms typically fall into four categories. The first is classification based filtering and matching, wherein a fingerprint can be classified into one of N types based on ridge direction flow (from a direction image). The class of the fingerprint (as global information) is used for filtering and clustering. A shortcoming of this method is that the class information is too coarse to be used for fingerprint matching and recognition. However, pseudo-ridge tracing based on direction image has been used to verify the print classification result, and because the pseudo-ridge contains detailed global structural information, it has been proposed for use in print matching.

The second method is minutiae based matching, wherein two prints are aligned and compared based on their respective minutiae points. A shortcoming of this method is that one area in the first print may be aligned with a different area in the second print due to distortion or noises, which may generate unreliable results. The third method is mated minutiae based secondary matching, wherein the local ridge structure along the mated minutiae is used to compare two prints, after minutiae matching is performed on the two prints. This approach can provide information as to whether or not the two compared areas are matched in ridge structure, but it cannot address the problem where mated minutiae are incorrectly identified during minutiae matching. Moreover, this method requires using a thin image or a gray scale image.

Finally, the fourth methods are Filter bank/Finger Code matching and phase correlation matching. Filter bank/Finger Code matching uses an average absolute deviation of a filtered image from a tessellated region to compare two prints. However, a shortcoming of this method is that it suffers badly when implemented on low quality images. Phase correlation can match low quality prints even without minutiae if both matched prints have similar texture pattern. However, existing phase correlation methods can also create a high correlation score for non-matching prints that have similar patterns, which is not desired, and phase correlation as currently implemented is slow compared to template feature-based matching.

Thus, due to the shortcomings of past and present print matching techniques and mechanisms, there continues to be a need for a print matching method and system that addresses at least some of these shortcomings.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 illustrates a block diagram of an AFIS implementing some embodiments.

FIG. 2 illustrates a method in accordance with some embodiments.

FIG. 3 illustrates a method in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, a system and method for fingerprint matching using phase correlation to improve overall system accuracy is described. More specifically, in an illustrative embodiment, search and file print images are pre-processed in the enrollment stage to extract relevant features, the print images compressed and the print images and extracted features stored in a suitable template. Examples of such templates include, but are not limited to, an American National Standards Institute (ANSI) or International Organization for Standardization (ISO) minutiae feature template in a user defined field, as is well known by those of ordinary skill in the art.

Based on one or more parameters including, but not limited to a Receiving Operator Characteristic (ROC) curve, classification type, minutiae score, image quality and ridge frequency/distance, only a selective set of file prints are re-matched with a search print using phase correlation in accordance with the teachings herein. Initial print alignment is based on mated minutiae or singularity points. Based on the initial alignment position, a set of phase correlation scores is calculated by rotating the search print or the file print left and right in a number of positions. The number of positions and the number of degrees for each position are defined for each correlation pair of images. If the number of mated minutiae falls below a threshold or for no mated singularity points between two compared prints, a larger number of rotation positions are used. The best correlation score is used as a decision parameter to boost or decrease the minutiae score in a limit range according to ROC curve accuracy requirement.

In accordance with embodiments, the phase correlation process can achieve an improved overall accuracy by more effective matching of lower quality prints, even where there are no detectible minutiae in the file print. This is because matching does not use the fine detail information such as minutiae or local ridge structure explicitly, but uses the texture pattern information. Moreover, the improved matching accuracy can be achieved without sacrificing system speed since only a subset of file prints are selected and matched using the phase correlation process, with the selection being made based on the one or more parameters including, e.g., print quality, minutiae matching score, ridge frequency/distance, etc. Accordingly, a print identification system using phase correlation pursuant to the various embodiments can be optimized to achieve a desired speed. Those skilled in the art will realize that the above recognized advantages and other advantages described herein are merely illustrative and are not meant to be a complete rendering of all of the advantages of the various embodiments.

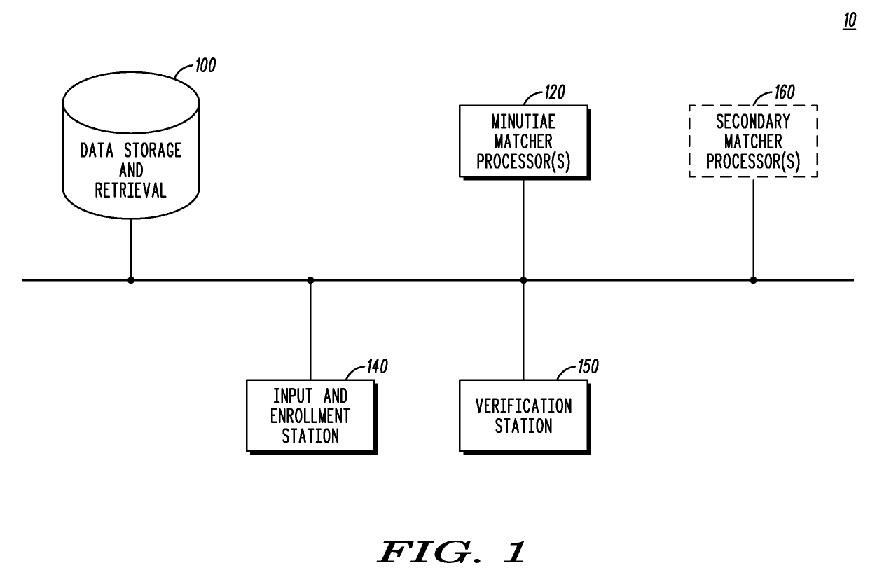

Referring now to the drawings, and in particular FIG. 1, a logical block diagram of an illustrative fingerprint matching system implementing some embodiments is shown and indicated generally at 100. Although fingerprints and fingerprint matching is specifically referred to herein, those of ordinary skill in the art will recognize and appreciate that the specifics of this illustrative example are not specifics of the invention itself and that the teachings set forth herein are applicable in a variety of alternative settings. For example, since the teachings described do not depend on the type of print being analyzed, they can be applied to any type of print (or print image), such as toe and palm prints (images). As such, other alternative implementations of using different types of prints are contemplated and are within the scope of the various teachings described herein.

System 100 is generally known in the art as an Automatic Fingerprint Identification System or (AFIS) as it is configured to automatically (typically using a combination of hardware and software) compare a given search print record (for example a record that includes an unidentified latent print image or a known ten-print) to a database of file print records (e.g., that contain ten-print records of known persons) and identify one or more candidate file print records that match the search print record. The ideal goal of the matching process is to identify, with a predetermined amount of certainty and without a manual visual comparison, the search print as having come from a person who has print image(s) stored in the database. At a minimum, AFIS system designers and manufactures desire to significantly limit the time spent in a manual comparison of the search print image to candidate file print images (also referred to in the art as respondent file print images).

Before describing system 100 in detail, it will be useful to define terms that are used herein and with regards to print matching.

A print is a pattern of friction ridges (also referred to in the art as “ridges”), which are raised portions of skin, and valleys between the ridges on the surface of a finger (fingerprint), toe (toe print) or palm (palm print), for example.

A print image is a visual representation of a print that is stored in electronic form. Herein, the terms print and print image are used interchangeably.

A gray scale image is a data matrix that uses values, such as pixel values at corresponding pixel locations in the matrix, to represent intensities of gray within some range. An example of a range of gray-level values is 0 to 255.

Image binarization is the process of converting a gray-scale image into a “binary” or a black and white image. A thin image is a binary image that is one pixel wide. A wide binary image is a binary image that preserves at least the shape and width of ridges and the shape of pores.

A minutiae point or minutiae is a small detail in the print pattern and refers to the various ways that ridges can be discontinuous. Examples of minutiae are a ridge termination or ridge ending where a ridge suddenly comes to an end and a ridge bifurcation where one ridge splits into two ridges.

A similarity measure is any measure (also referred to herein interchangeably with the term score) that identifies or indicates similarity of a file print (or record) to a search print (or record) based on one or more given parameters.

A direction field (also known in the art and referred to herein as a direction image) is an image indicating the direction the friction ridges point to at a specific image location. The direction field can be pixel-based, thereby, having the same dimensionality as the original fingerprint image. It can also be block-based through majority voting or averaging in local blocks of pixel-based direction field to save computation and/or improve resistance to noise. A number of methods exist to determine direction and smooth direction images.

A direction field measure or value is the direction assigned to a point (e.g., a pixel location) or block on the direction field image and can be represented, for example, as a slit sum direction, an angle or a unit vector.

A pseudo-ridge is the continuous tracing of direction field points, where for each point in the pseudo-ridge, the tracing is performed in the way that the next pseudo-ridge point is always the non-traced point with smallest direction change with respect to the current point or the several previous points.

A singularity point is a core or a delta.

In a fingerprint pattern, a core is the approximate center of the fingerprint pattern on the most inner recurve where the direction field curvature reaches the maximum.

According to ANSI-INCITS-378-2004 standard, a delta is the point on a ridge at or nearest to the point of divergence of two type lines, and located at or directly in front of the point of divergence.

Level-three features are defined for fingerprint images, for example, relative to level-one and level-two features. Level-one features are the features of the macro-scale, including cores/deltas. Level-two features are the features in more detail, including minutiae location, angles, ridge length and ridge count. Level-three features are of the micro-scale, including pores, ridge shape, ridge gray level distribution and incipient ridges. In comparison to level-one and level-two features which are widely available in current fingerprint images, level-three features are most reliably seen in high resolution, e.g., ≧1000 ppi (pixels per inch) images.

A decision logic is used in a biometric identification system to identify a print (or record) as being a strong match, a possible (weak) match or no match based on a match score generated by one or more matcher processors for that print (record).

A file print (record) is identified as a strong match when it has a corresponding match score that is greater than a highest non-matching score from a non-matching distribution curve generated from a biometric identification system, which also generated the file print's (record's) match score.

A file print (record) is identified as a possible match when it has a corresponding match score that is between two score thresholds, wherein at least one of the two thresholds is lower that the highest non-matching score.

A file print (record) is identified as no match when it has a corresponding match score that is below the two thresholds used to identify a possible match.

A match report is a list of candidates (prints or records depending on the search being implemented), which are sorted according to their match scores usually, but not necessarily, in descending order.

Ridge frequency is defined as the number of ridges per unit length along a vertical direction of local ridge orientation in the fingerprint.

Ridge distance is defined as the distance between two adjacent ridges along a vertical direction of the ridge orientation. It can be found from the inverse of the ridge frequency.

Aligning two images (e.g., print images and/or direction images) includes positioning, e.g., by rotating and translating, the two images in relation to one another. One type of alignment is feature based alignment. Feature based alignment can be done based on mated minutiae, wherein the two images are aligned such that there are a maximum number of mated minutiae detected between the images. Other feature based alignment methods may be used in addition to or alternatively to mated minutiae alignment, such as alignment based on cores and/or deltas, which is well known in the art, and therefore not discussed in detail here for the sake of brevity. Another type of alignment is image correlation alignment, which may be performed in either the spatial domain or the frequency domain.

Turning again to FIG. 1, an AFIS that may be used to implement the various embodiments of the present invention described herein is shown and indicated generally at 10. System 10 includes an input and enrollment station 140, a data storage and retrieval device 100, one or more minutiae matcher processors 120, a verification station 150 and optionally one or more secondary matcher processors 160. Embodiments may be implemented in one or more of the verification station 150 and the secondary matcher processor(s) 160, which in turn can be implemented using one or more suitable processing devices, examples of which are listed below.

Input and enrollment station 140 is used to capture fingerprint images to extract the relevant features (minutiae, cores, deltas, binary image, ridge features, etc.) of those image(s) to generate file records and a search record for later comparison to the file records. Thus, input and enrollment station 140 may be coupled to a suitable sensor for capturing the fingerprint images or to a scanning device for capturing a latent fingerprint.

Data storage and retrieval device 100 may be implemented using any suitable storage device such as a database, RAM (random access memory), ROM (read-only memory), etc., for facilitating the AFIS functionality. Data storage and retrieval device 100, for example, stores and retrieves the file records, including the extracted features, and may also store and retrieve other data useful to carry out embodiments. Minutiae matcher processors 120 compare the extracted minutiae of two fingerprint images to determine similarity. Minutiae matcher processors 120 output to the secondary matcher processors 160 at least one set of mated minutiae corresponding to a list of ranked candidate records associated with minutiae matcher similarity scores above some threshold. Secondary matcher processors 160 provide for more detailed decision logic using the mated minutiae and usually some additional features to output either a sure match (of the search record with one or more print records) or a list of candidate records for manual comparison by an examiner to the search record to verify matching results using the verification station 150.

It is appreciated by those of ordinary skill in the art that although input and enrollment station 140 and verification station 150 are shown as separate functional boxes in system 10, these two stations may be implemented in a product as separate physical stations (in accordance with what is illustrated in FIG. 1) or combined into one physical station in an alternative embodiment. Moreover, where system 10 is used to compare one search record for a given person to an extremely large database of file records for different persons, system 10 may optionally include a distributed matcher controller (not shown), which may include a processor configured to more efficiently coordinate the more complicated or time consuming matching processes.

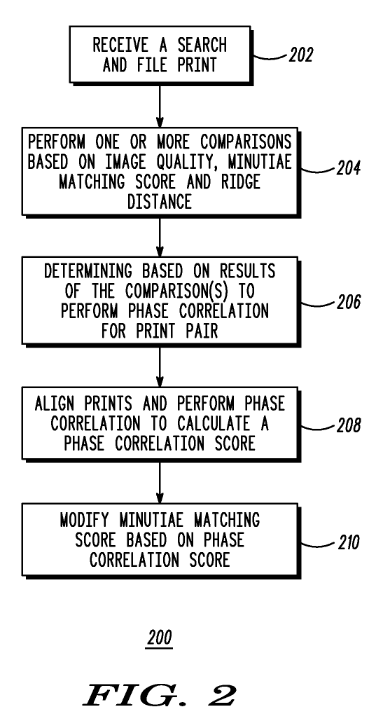

Turning now to FIG. 2, a flow diagram illustrating a method in accordance with some embodiments is shown and generally indicated at 200. In this illustrative implementation, method 200 is described in terms of a fingerprint identification process (such as one implemented in the AFIS shown in FIG. 1) for ease of illustration. However, it is appreciated that the method may be similarly implemented in biometric image identification for other types of prints such as, for instance, palm prints or toe prints without loss of generality, which are also contemplated within the meaning of the terms “print” and “fingerprint” as used in the various teachings described herein. Thus, all types of prints and images are contemplated within the meaning of the terms “print” and “fingerprint” as used in the various teachings described herein. Moreover, it should be noted that method 200 is described in terms of comparing prints. However, the method can be applied without loss of generality to print comparison at the record level (an in ten-print to ten-print matching), wherein match scores can be generated at the record level, as is well known in the art. Thus, in an implementation using record level matching, use of the term “print” in the claims and as described herein encompasses the term “record”, and the terms are used interchangeably as appropriate.

In general, method 200 comprises: receiving (202) a search print and a file print; performing (204) at least one of a first comparison of quality of the search and file prints to a quality threshold, a second comparison of a minutiae matching score for the search and file prints to a minutiae matching score threshold, and a third comparison of a ridge distance of the search and file prints to a ridge distance threshold; determining (206) that a phase correlation between the search and file prints is to be performed based on results of the at least one of the first, second and third comparisons; aligning (208) the search and file prints and performing the phase correlation to calculate a phase correlation score; and modifying (210) the minutiae matching score based on the calculated phase correlation score.

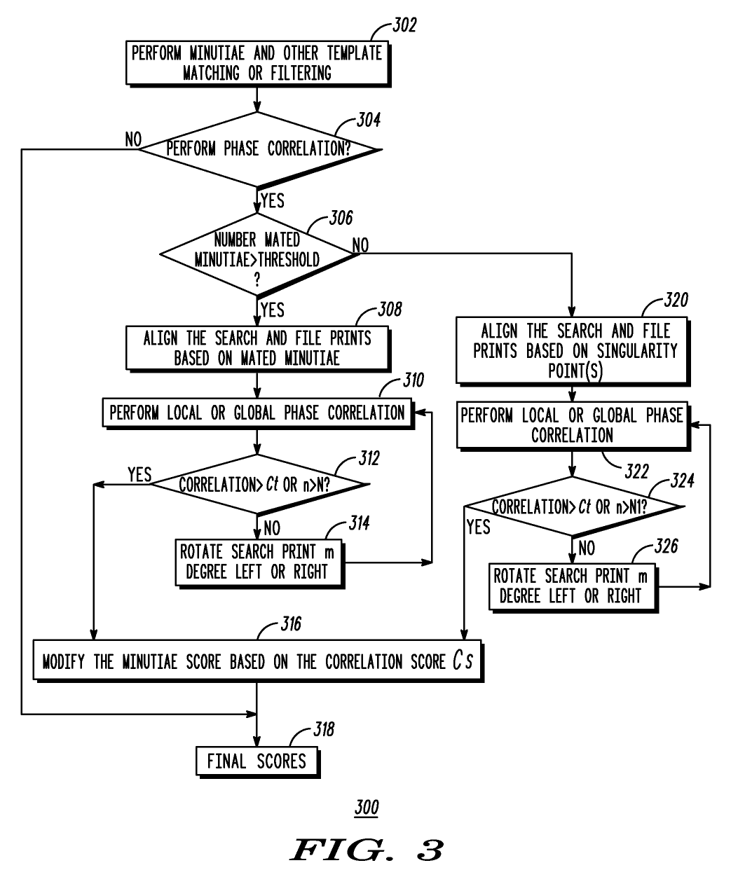

Illustrative details for implementing method 200 will next be described by reference to a method 300 of FIG. 3. This illustrative implementation is also described by reference to fingerprint matching but is equally applicable to other print matching. A search and file fingerprint or file fingerprints (e.g. for 1 to N matching) and relevant extracted features are received into any suitable interface within or into the fingerprint identification system to start the process. For example, the search print and features can be obtained from the input and enrollment station 140, and the file print(s) and features can be obtained from data storage and retrieval 100. At 302, minutia matching and optionally other template matching and filtering (e.g., classification filtering) is performed, and for each relevant file print a determination 304 is made as to whether to perform a phase correlation process in accordance with the teachings herein. In an efficient embodiment, only M file prints out of N file prints that were analyzed/filtered in 302 are further subject to the determination made at 304, wherein the M file prints represent the top M candidate file prints in a minutiae matching score report generated at 302. In an alternative but less efficient embodiment, each of the N file prints analyzed/filtered in 302 can be analyzed at 304 to determine whether the phase correlation process should be performed.

A shortcoming of known phase correlation processes is that the process is applied indiscriminately to the database file prints without the use of suitable filters, which results in some instances of high correlation scores being generated for non-matching (also referred to herein as “imposter”) prints. In accordance with the teachings herein, step 304 is used as a “filter”, if you will, for selecting those prints on which to perform the phase correlation process in order to avoid false high phase correlation scores and to, thereby, improve overall system accuracy and speed. At 304, such filtering can be performed based on one or more parameters including, but not limited to, classification filtering, core and/or delta filtering, minutiae matcher score, image quality and ridge distance. In this way, some imposter fingerprints, which would otherwise undesirably generate a high phase correlation score, may be filtered out before being matched by the phase correlation matcher to improve the matching speed by reducing the number of phase correlation matches.

For instance, with respect to the image quality, minutiae matcher score and ridge distance parameters, a comparison of these features from the search and file fingerprint pair with respective threshold values can serve as a filter at 304. These threshold values (and other threshold values described herein) can be determined experientially to give a desired accuracy and speed for a fingerprint identification system. In one illustrative implementation, a typical minutiae matcher can reliably match most fingerprints of reasonable quality to determine whether the search and file prints are or are not a match. Thus, a phase correlation process will be of minimal added value but will decrease the speed of the system. Accordingly, where the search and/or file prints having an average quality above a quality threshold Th_{q} (for example Th_{q}=30 on a scale of 0 minimum to 100 maximum) and/or a minutiae matcher score outside of a predetermined range as defined by an upper and lower threshold (for example Thₘₘₗ=3 and Thₘₘₕ=20 with a maximum minutiae matching score being 500), the search and file prints bypass the phase correlation process. Thus, the combination of image quality with the score of the minutiae matcher can be used as a filter for the phase correlation matcher.

Ridge distance may also be used in addition to image quality and minutiae matching score. More particularly, although some imposter fingerprints may generate high phase correlation coefficients (scores), they are very different in ridge distance. Therefore, a ridge distance threshold can be used to filter these imposter prints from undergoing the phase correlation matching process. Accordingly, the search and file prints bypass the phase correlation process if |1/Freqₛ−1/Freq_{f}|>Th_{rd}, wherein Freqₛ is the average ridge frequency of the search image s(n₁, n₂), Freq_{f} is the average ridge frequency of the file image f(n₁, n₂ ), and Th_{rd} is a ridge distance threshold that is set to 3. The average ridge frequency is found by averaging the total number of ridge frequency for all blocks within the valid region of fingerprint image.

Using the above thresholds in one illustrative embodiment, for a search and file print pair where the minutiae matching score is in the range of 3 to 20 and either one or both of the search and file prints have an average quality under 30 and |1/Freqₛ−1/Freq_{f}|>3, the method 300 proceeds to 306. Otherwise, the process proceeds to 318 where a final score is generated based, for instance, on a minutiae matching score for the fingerprint pair that is not modified by the phase correlation matching process. As stated above, other parameters may be used instead of or in addition to image quality, ridge distance, and minutiae matching score (and in any suitable combination) within the scope of the teachings herein.

At 306, another determination is made based on a number of mated minutiae between the search and file prints whether the process proceeds to 308 or 320. The number of mated minutiae is obtained from the minutiae matching of 302 and compared to a threshold, e.g., 3 in this case, and if the mated minutiae exceed the threshold, the process proceeds to 308, otherwise it proceeds to 320. The purpose of the determination at 306 is to decide whether we can use the mated minutiae to estimate transformation parameters so that two fingerprints can be reliably aligned for the correlation calculation. Accordingly, where the number of mated minutiae is greater than 3 (as we take the case to be at this juncture), the search and file prints are aligned (308) to an initial alignment based on the mated minutiae, and the phase correlation matching performed (310). In addition, at 308 a counter “n” is set to zero, wherein n counts the number of times phase correlation is performed for the instant search and file print pair, as described below in further detail.

In one embodiment, a fixed bandwidth limited phase correlation is performed at 310 as follows. Consider two N₁×N₂ images, s(n₁, n₂) and f(n₁, n₂), where n₁=0, . . . , N₁−1 and n₂=0, . . . , N₂−1. Let S(k₁, k₂) and F(k₁, k₂) denote the two-dimensional Discreet Fourier Transforms (2D DFTs) of the two images. F(k₁, k₂) is given by

$$S ( {k}_{1} , {k}_{2} ) = {\sum }_{{n}_{1} , {n}_{2}} S ( {n}_{1} , {n}_{2} ) {W}_{{N}_{1}}^{{k}_{1} {n}_{1}} {W}_{{N}_{2}}^{{k}_{2} {n}_{2}} = {A}_{S} ( {k}_{1} , {k}_{2} ) {e}^{{jθ}_{S} ( {k}_{1} , {k}_{2} )} ,$$

where k₁=0, . . . , N₁−1, k₂=0, . . . ,

$${N}_{2} - 1 , {W}_{{N}_{1}} = {e}^{- j \frac{2 π}{{N}_{1}}} , {W}_{{N}_{2}} = {e}^{- j \frac{2 π}{{N}_{2}}} ,$$

and

$${\sum }_{{n}_{1} , {n}_{2}} denotes {\sum }_{{n}_{1} = 0}^{{N}_{1} - 1} {\sum }_{{n}_{2} = 0}^{{N}_{2} - 1} .$$

A_{S}(k₁, k₂) is the amplitude and θ_{S}(k₁, k₂) is the phase. F(k₁, k₂) is defined in the same way. The cross-phase spectrum R_{SF}(k₁, k₂) is given by

$${R}_{SF} ( {k}_{1} , {k}_{2} ) = \frac{S ( {k}_{1} , {k}_{2} ) \overline{F ( {k}_{1} , {k}_{2} )}}{\vert S ( {k}_{1} , {k}_{2} ) \overline{F ( {k}_{1} , {k}_{2} )} \vert} = {e}^{jθ ( {k}_{1} , {k}_{2} )} ,$$

where F̅(̅k̅₁̅,̅ k̅₂̅)̅ is the complex conjugate of F(k₁, k₂) and θ(k₁, k₂) denotes the phase difference θ_{S}(k₁, k₂)−θ_{F}(k₁, k₂). The phase correlation function r_{sf}(n₁, n₂) is the 2D Inverse DFT of R_{SF}(k₁, k₂) and is given by

$${r}_{sf} ( {n}_{1} , {n}_{2} ) = \frac{1}{{N}_{1} {N}_{2}} {\sum }_{{k}_{1} , {k}_{2}} {R}_{SF} ( {k}_{1} , {k}_{2} ) {W}_{{N}_{1}}^{- {k}_{1} {n}_{1}} {W}_{{N}_{2}}^{- {k}_{2} {n}_{2}} , \\ where {\sum }_{{k}_{1} , {k}_{2}} denotes {\sum }_{{k}_{1} = 0}^{{N}_{1} - 1} {\sum }_{{k}_{2} = 0}^{{N}_{2} - 1} .$$

When two images are similar, their phase correlation function gives a distinct sharp peak. When two images are not similar, no sharp peak appears in their phase correlation function.

Although this fixed phase correlation is suitable for some fingerprint image pairs, it is not suitable in all cases and may remove some useful information needed for accurate matching and may not remove high frequency noise. Therefore in another embodiment, a dynamic bandwidth limited phase correlation can be used to overcome these shortcomings of the fixed bandwidth limited method and may improve accuracy notwithstanding the variations in ridge frequency between fingerprints.

The dynamic bandwidth limited phase correlation function is given by

$${r}_{sf}^{′} ( {n}_{1} , {n}_{2} ) = \frac{1}{( {N}_{12} - {N}_{11} ) ( {N}_{22} - {N}_{21} )} {\sum }_{{k}_{1} = {N}_{11}}^{{N}_{12} - 1} {\sum }_{{k}_{2} = {N}_{21}}^{{N}_{22} - 1} {R}_{SF} ( {k}_{1} , {k}_{2} ) {W}_{( {N}_{12} - {N}_{11} )}^{- {k}_{1} {n}_{1}} {W}_{( {N}_{22} - {N}_{21} )}^{- {k}_{2} {n}_{2}}$$

where, N₁₁ and N₁₂ are determined by

$$\{ \begin{matrix}Mean ( {A}_{S} ) = \frac{1}{{N}_{1} {N}_{2}} {\sum }_{{k}_{1} = 0}^{{N}_{1} - 1} {\sum }_{{k}_{2} = 0}^{{N}_{2} - 1} {A}_{S} ( {k}_{1} , {k}_{2} ) \\ \frac{1}{{N}_{2}} {\sum }_{{k}_{2} = 0}^{{N}_{2} - 1} {A}_{S} ( {k}_{1}^{′} , {k}_{2} ) = Mean ( {A}_{S} ) * λ \\ {N}_{11} = min ( {k}_{1}^{′} ) \\ {N}_{12} = max ( {k}_{1}^{′} )\end{matrix}$$

N₂₁ and N₂₂ are determined by

$$\{ \begin{matrix}Mean ( {A}_{S} ) = \frac{1}{{N}_{1} {N}_{2}} {\sum }_{{k}_{1} = 0}^{{N}_{1} - 1} {\sum }_{{k}_{2} = 0}^{{N}_{2} - 1} {A}_{S} ( {k}_{1} , {k}_{2} ) \\ \frac{1}{{N}_{1}} {\sum }_{{k}_{1} = 0}^{{N}_{1} - 1} {A}_{S} ( {k}_{1}^{′} , {k}_{2} ) = Mean ( {A}_{S} ) * λ \\ {N}_{21} = min ( {k}_{2}^{′} ) \\ {N}_{22} = max ( {k}_{2}^{′} )\end{matrix}$$

In the fixed bandwidth limited method, N₁₁, N₁₂, N₂₁ and N₂₂ are constants. In the dynamic bandwidth limited method, these parameters are found by solving the above equations, wherein A_{S}(k₁, k₂) is the amplitude of S(k₁, k₂); λ is a constant determined by experience and can, for example, be set to 1.5. The fixed and dynamic phase scores Cs are found from the ratio of maximum peak coefficient value to the average coefficient values of fixed and dynamic phase correlation functions respectively. The coefficient value is the magnitude of the phase correlation function. Since the correlation function is complex, the magnitude is defined to be the positive square root of the complex number times its complex conjugate.

The above-described correlation is referred to as “global phase correlation” since the phase correlation score, Cs, is calculated based on the entire or substantially the entire search and file print images. However, in some cases where a certain level of distortion is present in any one of the fingerprint images, using a “local phase correlation”, which calculates the phase correlation score based only on a portion of the fingerprint images, gives greater accuracy for the distorted images.

In accordance with this local phase correlation, the f(n₁, n₂) image is divided into m blocks, with the size of the blocks depending at least in part on a distortion measure of fingerprint area. Each block image is correlated with the s(n₁, n₂) image using the above phase correlation function to generate m phase correlation scores. The maximum of the m phase correlation scores is selected as the final score output from 310. In an embodiment, m can be set to 4.

As stated, local phase correlation is applied when a certain level of distortion is present in the print images. In order to determine whether to apply the local phase correlation method, a distortion measurement analysis (or distortion measure) is applied before performing any correlation method. In one illustrative implementation, the distortion measure analyzes the inconsistency of the local ridge frequency in one or both of print images. The inconsistency of the local ridge frequency is analyzed by evaluating a ridge frequency map to find whether there is an area whose ridge frequency is severally different from the other areas, e.g., whether the difference between the ridge distance of the area to the average ridge distance of the image is greater than a threshold pre-determined from experiment For example, the threshold can be set to 3.

Output from 310 is a correlation score associated with the fingerprint image pair. Moreover, counter n is increased by 1 (or set to n=n+1) to reflect that the phase correlation has been performed. At 312, the correlation score generated from 310 is compared with a correlation threshold, Ct, to determine whether additional phase correlation should be performed for the fingerprint pair in order to optimize the accuracy of the process. If the correlation score is less than Ct (which in one implementation is set to 10), then one of the prints is rotated (314) to the left or right a number of degrees (for example five degrees) to re-align the print images, and phase correlation (310) is performed again at the new alignment. In an embodiment, the search print is rotated if the search print size is smaller than the file print size to achieve a speed advantage.

This re-alignment can be performed a fixed number of times to calculate a maximum phase correlation score that is used, at 316, to modify the minutiae matching score corresponding to the fingerprint pair. In another implementation, as illustrated in FIG. 3, the re-alignment (314) and corresponding phase correlation (310) is performed until the generated correlation score exceeds the threshold or until n>N, wherein N is set to 9, for instance. When the process proceeds to 316 based on the correlation score exceeding the correlation score threshold, this correlation score is taken as the maximum correlation score for the score fusion performed at 316, which boosts or decreases the minutiae matching score for the fingerprint pair. Otherwise, the maximum of the nine correlation scores is taken (or an average) to use in the score fusion.

A suitable algorithm can be used to modify the minutiae matching score using the phase correlation score. The following fusion method, however, has an advantage of modifying the minutiae matching score only in a predetermined range and based on a Receiver Operator Characteristic (ROC) curve for the fingerprint matching system, in order to minimize the chance of a high correlation score being generated for non-matching fingerprint pairs. In an illustrative implementation, if the correlation score Cs is greater than a threshold T₁, increase the similarity score of the minutiae matcher to a limited range according a formula or modification function; if the correlation score Cs is less than a threshold T₂, decrease the similarity score of the minutiae matcher to a limited range according to another formula. The final score is given by

$${s}^{′} = \{ \begin{matrix}s + {β}_{1} + {α}_{1} ( Cs - {T}_{1} ) & if Cs > {T}_{1} \\ s - {β}_{2} - {α}_{2} ( {T}_{2} - Cs ) & if Cs < {T}_{2}\end{matrix} ,$$

where s is the minutia matching score and α₁, β₁, α₂ and β₂ are constants determined by experience. For example, α₁, β₁, α₂ and β₂ are set to 3, 4, 2, and 2, respectively. Moreover, T₁ and T₂ are determined by the ROC curve that illustrates distributions of imposter correlation scores versus genuine correlation scores, and can be set, for example, to 8 and 5 respectively.

As mentioned above, where the number of mated minutiae for a given fingerprint pair is below the mated minutiae threshold, the process proceeds to 320. At 320, the fingerprint images are aligned based on singularity points as is well known in the arts. Functions 322, 324 and 326 are identical to functions 310, 312 and 314 described above except that the threshold N1 is set to a higher number, for instance 18. The reason that N1 is set to be higher than N is that the initial alignment using the mated minutiae is normally more accurate than the initial alignment of singularity points or center of fingerprint (actually no alignment using the center of fingerprint). Thus N1 is set to be a larger number to cover a larger range of the possible alignments. Upon exiting the loop at 324, score fusion is performed at 316. For 1-to-many matching, at 318 the revised minutiae matching scores are sorted into a sorted list so that each file print can be identified as a strong match, a possible (weak) match or no match.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for print matching using phase correlation described herein. The non-processor circuits may include, but are not limited to, a radio receiver, a radio transmitter, signal drivers, clock circuits, power source circuits, and user input devices. As such, these functions may be interpreted as steps of a method to perform the print matching using phase correlation described herein described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage medium having computer readable code stored thereon for programming a computer (e.g., comprising a processing device) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving a search print and a file print;
performing at least one of a first comparison of quality of the search and file prints to a quality threshold, a second comparison of a minutiae matching score for the search and file prints to a minutiae matching score threshold, and a third comparison of a ridge distance of the search and file prints to a ridge distance threshold;
determining that a phase correlation between the search and file prints is to be performed based on results of the at least one of the first, second and third comparisons;
aligning the search and file prints and performing the phase correlation to calculate a phase correlation score; and
modifying the minutiae matching score based on the calculated phase correlation score.

2. The method of claim 1 further comprising the step of realigning one of the prints at least one time to generate a maximum phase correlation score, and modifying the minutiae matching score based on the maximum phase correlation score.

3. The method of claim 2, wherein the one of the prints is rotated a number of degrees to realign the print.

4. The method of claim 2, wherein the one of the prints is realigned when the calculated phase correlation score is less than a correlation threshold.

5. The method of claim 2, wherein the one of the prints is realigned a fixed number of times to calculate the maximum phase correlation score.

6. The method of claim 1, wherein the search and file prints are aligned based on one of a number mated minutiae and singularity points in the search and file prints.

7. The method of claim 6, wherein the search and file prints are aligned based on the number of mated minutiae when the number of mated minutiae exceeds a mated minutiae threshold.

8. The method of claim 1, wherein the phase correlation comprises one of a local phase correlation wherein the phase correlation score is calculated based on a portion of the search and file prints and a global phase correlation wherein the phase correlation score is calculated based on the entire search and file prints.

9. The method of claim 8 further comprising applying a distortion measure to the search and file prints to determine whether to use the local phase correlation or the global phase correlation.

10. The method of claim 9, wherein the distortion measure analyzes inconsistency in local ridge distance.

11. The method of claim 1, wherein the phase correlation comprises a dynamic bandwidth limited correlation function.

12. The method of claim 1, wherein the minutiae matching score is modified within a predetermined range using a modification function.

13. A system comprising:
an interface receiving a search print and a file print; and
a processing device,
performing at least one of a first comparison of quality of the search and file prints to a quality threshold, a second comparison of a minutiae matching score for the search and file prints to a minutiae matching score threshold, and a third comparison of a ridge distance of the search and file prints to a ridge distance threshold;
determining that a phase correlation between the search and file prints is to be performed based on results of the at least one of the first, second and third comparisons;
aligning the search and file prints and performing the phase correlation to calculate a phase correlation score; and
modifying the minutiae matching score based on the calculated phase correlation score.

14. The system of claim 13, wherein the system is an Automatic Fingerprint Identification System (AFIS).

15. A computer-readable storage medium having computer readable code stored thereon for programming a computer to perform a method upon receiving a search print and a file print, the method comprising:
performing at least one of a first comparison of quality of the search and file prints to a quality threshold, a second comparison of a minutiae matching score for the search and file prints to a minutiae matching score threshold, and a third comparison of a ridge distance of the search and file prints to a ridge distance threshold;
determining that a phase correlation between the search and file prints is to be performed based on results of the at least one of the first, second and third comparisons;
aligning the search and file prints and performing the phase correlation to calculate a phase correlation score; and
modifying the minutiae matching score based on the calculated phase correlation score.

16. The computer-readable storage medium of claim 15, wherein the computer readable storage medium comprises at least one of a hard disk, a CD-ROM, an optical storage device, a magnetic storage device, a ROM (Read Only Memory), a PROM (Programmable Read Only Memory), a EPROM (Erasable Programmable Read Only Memory), a EEPROM (Electrically Erasable Programmable Read Only Memory) and a Flash memory.
